(19) United States
(12) Patent Application Publication
(10) Pub. No.: US 2026/0277596 A1
(43) Pub. Date: Sep. 17, 2026

(54) AGENTIC ARTIFICIAL INTELLIGENCE FOR INTERACTIVE AND INCREMENTAL SOFTWARE DEVELOPMENT

(71) Applicant: Todd Christopher Wildey, Seattle, WA (US)

(72) Inventor: Todd Christopher Wildey, Seattle, WA (US)

(21) Appl. No.: 19/565,298

(22) Filed: Mar. 12, 2026

Related U.S. Application Data
(60) Provisional application No. 63/771,235, filed on Mar. 13, 2025.

(51) Int. Cl. G06F 8/658; G06F 8/35; G06N 20/00

(52) U.S. Cl. CPC G06F 8/658; G06F 8/35; G06N 20/00

(57) ABSTRACT

The embodiments described herein are directed to systems and methods that use agentic artificial intelligence for interactive and incremental software development. An agentic code generating system receives a natural language description of at least one task, purpose, or function of a target software. The system obtains initial code for the target software and output cumulative modifications to the initial code that correspond to a plurality of intermediate states of development toward final code for the target software by using one or more trained machine learning models. At a subset of the intermediate states, the system obtains interactions with a cumulative modification corresponding to the intermediate state and generate subsequent cumulative modifications based on a revised intermediate state. Final code for the target software is outputted and the trained machine learning models are updated based on the final code and the interactions obtained with the cumulative modifications.

### CROSS-REFERENCE TO RELATED APPLICATION(S)

This Application claims the benefit of Provisional Patent Application Number 63/771,235, filed Mar. 13, 2025, and entitled “AGENTIC ARTIFICIAL INTELLIGENCE (AI) FOR INTERACTIVE AND INCREMENTAL SOFTWARE DEVELOPMENT,” which is hereby incorporated by reference in its entirety.

In cases where the present application conflicts with a document incorporated by reference, the present application controls.

### BACKGROUND

AI-driven coding assistants can propose or perform edits to source code and related project artifacts. Some systems provide automated refactoring, code generation, or multi-file changes based on natural language instructions and contextual signals derived from a developer workspace.

### BRIEF DESCRIPTION OF THE DRAWINGS

FIG. 1 is a block diagram showing some of the components typically incorporated in at least some of the computer systems and other devices on which the system operates.

FIG. 2 is a block diagram showing the interaction of an agentic code generation system with a user device, according to various embodiments described herein.

FIG. 3 is a data flow diagram of the flow of data between various components of the agentic code generation system, according to various embodiments described herein.

FIG. 4 is a flow diagram of a sample process to convert initial code into final code for target software, according to various embodiments described herein.

FIG. 5 is a flow diagram of a sample process to respond to user interaction with a code document during the conversion of initial code into final code, according to various embodiments described herein.

FIG. 6 is a flow diagram of a sample process to determine whether an action associated with an intermediate state can be automatically performed, according to various embodiments described herein.

FIG. 7 is a flow diagram of a sample process to identify one or more sub-tasks for the conversion of the initial code into final code for the target software, according to various embodiments described herein.

FIG. 8A is a display diagram of a first user interface, according to various embodiments described herein.

FIG. 8B is a display diagram of a second user interface, according to various embodiments described herein.

FIG. 8C is a display diagram of a third user interface, according to various embodiments described herein.

FIG. 8D is a display diagram of a fourth user interface, according to various embodiments described herein.

FIG. 8E is a display diagram of a fifth user interface, according to various embodiments described herein.

### DETAILED DESCRIPTION

AI-driven coding assistants are used to propose or perform edits to code for software code and related project artifacts. However, conventional AI coding assistants suffer from a myriad of technical problems. For example, conventional AI coding assistants can cause destructive or unintended workspace modifications when they have direct write access. Furthermore, edits generated by conventional AI coding assistants may be generated by using stale file content, which risks overwriting user changes or corrupted merges of code performed by version control software. Conventional AI coding assistants also may be inadvertently granted access to sensitive files, directories, or operations outside of the scope of their task. Additionally, conventional AI coding assistants do not have a log of the actions taken when making changes to the code. Also, conventional AI coding assistants trained by using the same tool schema and prompt structure may produce less reliable tool calls or arguments.

In response to these disadvantages, the inventor has conceived and reduced to practice an agentic code generation system. The agentic code generation system may prevent untrusted model output from directly affecting a workspace, enforce a local policy or receive authorization before changes are made, allow user edits to be made to the code while code is being generated, generate trace data that tracks the changes made by the agentic code generation, perform reinforcement learning with respect to prompts and actions, or a combination thereof.

In some embodiments, the agentic code generation system uses one or more machine learning models to generate one or more declarative actions (e.g., “edit file X with edit script Y under precondition hash H”). In some embodiments, the actions are evaluated against a trust policy to determine whether user approval is required to take the action. Actions that are approved, or that do not need approval, are routed to a workspace executor that causes the action to be performed.

In some embodiments, the action is recorded in an action history. In some embodiments, the action history includes an indication of the prompt, a tool used to perform an action, an action, one or more arguments, other action history data, or a combination thereof. In some embodiments, the action history is used to train a machine learning model.

In an example embodiment, the system may receive natural language text data indicating a task for a target software and generate one or more prompts for actions to complete the task based on the natural language text data. In this example, the system generates the prompts based on the natural language text data and a state of the codebase that makes up the target software. The system may determine that a file is to be edited in order to execute a proposed action and generate an edit script and one or more concurrency hashes. The system transmits data indicating the proposed action, edit script, and concurrency hashes to a policy enforcement module that determines whether the action is to be automatically performed, forbidden, or whether permission is necessary to perform the action. If permission to perform the action is granted, or the action is to be automatically performed, an executor proceeds with performing the action. In this example, the executor uses the concurrency hashes and a hash generated from the file to be edited to determine whether the edit script is to be executed. If the executor determines that the edit script is to be executed, the executor applies the edit by using the edit script. In this example embodiment, the executor transmits an indication to the system that the edit was successful.

In another example embodiment, the executor may determine that the generated file hash and an expected file hash are not correct, and the execution is rejected. Such a situation may occur when a state of the codebase changes in the time between the state of the codebase being provided to the system and the proposed actions are generated, for example if a user has modified the file during this time period. In such an example embodiment, the system may be caused to generate a new proposed task based on the natural language text data and an updated state of the codebase that includes the changes that the user made. In this example, it may be determined that the codebase changed based on a comparison of the generated hash file and expected hash file.

In another example embodiment, a user may edit a file locally in their IDE. The system may record the local edits and automatically aggregate them into a cumulative edit action. If the system is also currently making changes to the state of the codebase, the process of making the changes is paused until the user has finished their edits. The new version of the state of the codebase is transmitted to the system, and the system re-generates proposed actions based on the new version of the state of the codebase.

By performing in some or all of the ways described above, the system improves the ability of agentic code generation tools to make changes concurrently with changes made by a user, keep track of changes to the codebase, and ensure that forbidden changes are not made to the codebase. Also, the system improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, when changes are made to a codebase during the generation of code in conventional systems, the changes are not reflected in the generated code, and additional memory resources and processing cycles must be used to re-generate the code to take into account the changes. However, by using hashes to identify when a state of the codebase has changed and re-generating proposed actions while the system is already generating code for the target software, fewer processor cycles and less memory is expended to automatically generate code from scratch because the proposed actions for generating the code can be adjusted to take into account the changes.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

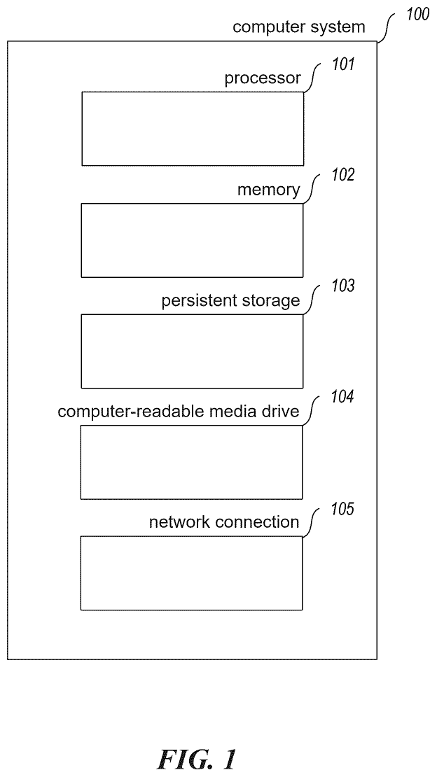

FIG. 1 is a block diagram showing some of the components typically incorporated in at least some of the computer systems and other devices on which the system operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the system and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the system, those skilled in the art will appreciate that the system may be implemented using devices of various types and configurations, and having various components.

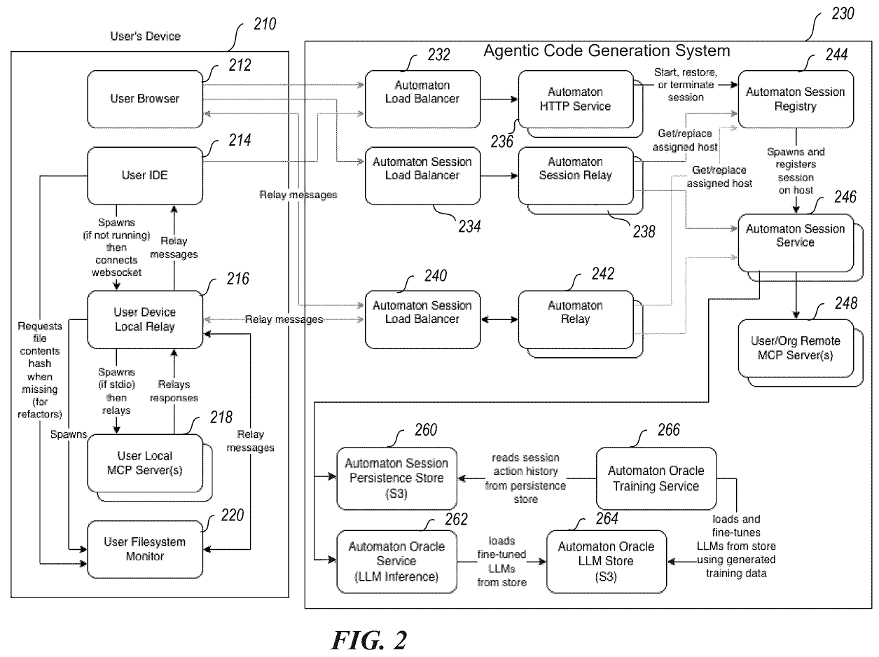

FIG. 2 is a block diagram showing the interaction of an agentic code generation system 230 with a user device 210, according to various embodiments described herein. In FIG. 2, the user device 210 communicates with the agentic code generation system 230 (the “system 230”) to generate code in response to a prompt and change a codebase or related files based on the generated code. The user device 210 may include a browser 212, an integrated development environment (“IDE”) 214, a local relay 216, access to one or more local MCP servers 218, and a filesystem monitor 220.

The browser 212 may be a web browser, such as Firefox, Chrome, Edge, etc. A user of the user device 210 may use the browser 212 as an interface to communicate with the system 230, such as to submit prompts to the system 230, provide an indication of settings for the system 230, provide the system 230 with control over the IDE 214, to communicate other data between the user device 210 and system 230, or a combination thereof. In some embodiments, the user device 210 is configured to display a user interface for communicating with the system 230 without using a browser 212.

The IDE 214 may be any type of integrated development environment usable for developing code, such as Visual Studio, VS Code, Python IDE, Eclipse, or other integrated development environments. The IDE 214 may be configured to transmit data to the system 230, receive data from the system 230, or a combination thereof. The data received by the IDE 214 from the system 230 may be used to control or manipulate one or more user interface elements of the IDE 214 to change code associated with a target software. The data transmitted to the system 230 from the IDE 214 may include data indicating documents or files that indicate a current state of the software code, data indicating a user's interaction with the IDE 214, other data associated with the IDE 214, or a combination thereof. The IDE 214 may receive instructions from the system 230 via the local relay 216, via workspace executor configured to execute instructions received from the local relay 216, or a combination thereof.

The local relay 216 receives instructions from the system 230 indicating actions that are proposed to be taken by the IDE 214—such as actions to manipulate or control one or more user interface elements of the IDE 214 to change code associated with a target software. In some embodiments, the actions may include actions to change documentation, other files associated with the development of the target software, or a combination thereof. In some embodiments, the actions may be taken by the IDE 214, a local filesystem daemon (such as the filesystem monitor 220), one or more local MCP servers (such as the local MCP servers 218), or a combination thereof. The local relay 216 may determine whether to allow the actions to be automatically taken, to request user input regarding the actions, or to prevent the actions from being taken, based on a source of the instructions, a trust policy indicating permitted actions, a trust policy indicating forbidden actions, a trust policy indicating actions that require approval, a type of the action, other data associated with the actions, or some combination thereof. For example, the local relay 216 may have a policy permitting files to be listed, permitting files to be opened, permitting movement of the cursor, and permitting data to be requested from a user. The local relay 216 may also have a policy requiring user approval before a file is edited, before a file is moved, before a file is created, and when an action is received from a selected entity. Furthermore, the local relay 216 may have a policy forbidding the deletion of a file. In this example, the local relay 216 may automatically perform actions related to opening files and moving the cursor, request approval before a file is edited or created, and will prevent an action indicating that a file is to be deleted from being executed. In another example, the local relay 216 may permit a file to be deleted if permissions to perform that action is included in the trust policy. In some embodiments, the instructions include one or more declarative actions that indicate a proposed action as a structured message. For example, a declarative action may be to “edit file X with edit script Y under precondition hash H”.

The MCP servers 218 are local model context protocol servers used by the user device 210 to provide tools that can be invoked by a machine learning or artificial intelligence model, such as one or more machine learning or artificial intelligence models of the system 230. In an example embodiment, a machine learning model of the system 230 generates an action that indicates one or more tools of the MCP servers 218. In this example, the system 230 transmits a message to the local relay 216 to invoke the tool to take the generated action. A tool response is generated by the MCP servers 218 in response to the invocation of the tools, and the tool response is transmitted to the local relay 216 to transmit to the system 230. In such an embodiment, the tool response may be used as context in a prompt generated by the system 230 for the machine learning model. In some embodiments, the user device 210 may use protocols other than the model context protocol.

The user filesystem monitor 220 detects file events and performs file operations with respect to files associated with the code for the target software. The filesystem monitor 220 may detect whether the user has updated a file, added a file, removed a file, etc. In some embodiments, the filesystem monitor 220 performs file operations with respect to instructions received from the local relay 216. For example, the user filesystem monitor 220 may read, write, or a combination thereof, file contents to a filesystem of the user's device. When the filesystem monitor 220 completes reading or writing file contents, it may send a response message through the local relay 216 that is transmitted to the agentic code generation system 230. In such an example, the IDE 214 may be registered to listen for events of the namespace for the filesystem monitor 220, and the IDE 214 may also receive response events from the filesystem monitor 220 when reading or writing file contents completes. The IDE 214 may update or reload file contents based on the response events from the filesystem monitor 220 indicating that reading or writing file contents has been completed.

The system 230 includes one or more load balancers 232, 234, and 240, an HTTP service 236, one or more relays 238 and 242, a session registry 244, a session service 246, a remote MCP server 248, a session persistence store 260, an oracle service 262, an oracle LLM store 264, and an oracle training service 266. The MCP server 248 and relays 242 and 238 perform similar functions to the MCP server 218 and local relay 216 of the user device 210. The load balancers 232, 234, and 240 distribute data received from or transmitted to the user device to the appropriate relays or services of the system 230. In some embodiments, the load balancers 232, 234, and 240 are optional. The HTTP service 236, session registry 244, and session service 246, are used to manage a session between the user device 210 and system 230 for transmitting data between the user device 210 and system 230.

The oracle service 262 may include one or more machine learning models, such as artificial intelligence or machine learning models trained to generate software code for a target software, identify tasks within a prompt, generate an indication of intermediate states of development for developing code in an initial state to a final state, attribute the completion of one or more tasks to one or more intermediate states, perform other operations described herein, or some combination thereof. In some embodiments, the system 230 further trains the at least a portion of the one or more machine learning models based on data indicating a prompt received from a user device 210, one or more intermediate states, and one or more interactions from a user with the code. In some embodiments, the one or more machine learning models receive as input a prompt, an indication of the state of one or more files associated with the target software, other data, or a combination thereof. In some embodiments, one or more of the machine learning models are natural language models. A user, the system 230, the user device 210, or a combination thereof, may interact with the one or more machine learning models via an artificial intelligence agent.

In various example embodiments, the system 230 generates one or more code-editing actions and uses a policy to evaluate whether the proposed actions are able to be taken. In such example embodiments, the system 230 may include or communicate with an executor system configured to perform operations in response to a determination that the proposed actions are permitted by the policy. In some embodiments, the system 230 communicates with a policy enforcement module, such as the local relay 216, and the policy enforcement module communicates with the executor system.

In some embodiments, the proposed actions comprise a structured message including a namespace, an action type, an action identifier, one or more action parameters, other data related to a proposed action, or a combination thereof. In some embodiments, an executor system corresponding to the namespace and type of action is used to perform a proposed action. In some embodiments, one or more executor systems are used to perform operations based on the proposed actions. In such embodiments, each executor system may be associated with a namespace. In some embodiments, actions may be routed to executor systems based on a namespace associated with the action.

In some embodiments, the policy comprises one or more rules, such as rules forbidding one or more actions, rules requiring user permission to perform one or more actions, rules allowing one or more actions to be automatically performed, or a combination thereof. In some embodiments, an IDE client is configured to present an interface requesting user permission to perform one or more actions. In some embodiments, a policy enforcement module transmits a request for permission to perform an action including a description of an action and one or more action parameters.

In some embodiments, the executor edits a file by executing an edit script comprising a list of text mutations. In some embodiments, the executor rejects an edit when a hash generated based on the current file does not match an expected content hash associated with the proposed action. In some embodiments, the proposed action is associated with a new content hash, and the executor verifies that the resulting file content hash matches the new content hash after an edit script is applied. In some embodiments, the policy enforcement module transmits an execution result back to the system 230 that includes an updated content hash, an indication of whether the action was successful, other related to the result of the action, or a combination thereof.

In some embodiments, the system 230 includes a persistence subsystem configured to persist one or more proposed action payloads, one or more approval decisions, one or more execution results, one or more session state snapshots, or a combination thereof. In some embodiments, the persistence subsystem stores data based on one or more content hashes associated with the data. In some embodiments, the persistence subsystem records parent pointers between actions to form an ordered action history.

In some embodiments, the system 230 generates training data including one or more prompts rendered from a session state, one or more actions corresponding to the prompts, one or more action arguments corresponding to the prompts, or a combination thereof. In some embodiments, the training data includes a tool manifest defining actions and parameter schemas. In some embodiments, the tool manifest includes content-type designations and training examples enforce content-type constraints on action arguments.

In some embodiments, the executor restricts file operations to allowed workspace directories and enforces ignore patterns to exclude files or directories. In some embodiments, the workspace executor captures file events. In some embodiments, the file events include a hash generated before the event, a hash generated after the event, an edit summary, or a combination thereof. In some embodiments, the system 230 maintains a cache of file hashes derived from file events. In such embodiments, the system 230 may use cached hashes to populate expected content hashes in subsequent edits.

In some embodiments, the system 230 records one or more action sequences associated with the completion of a task. In such embodiments, the system 230 may determine a net number of actions that transform an initial state of the code at task creation to a final state of the code at task completion. In some embodiments, the training data includes training examples from the net actions. In such embodiments, the training data does not need to include data from the full action sequence. In some embodiments, the system 230 generates the training data.

In some embodiments, a session for using the system to generate code begins in a disabled state in which the user takes actions to change the state of the codebase. In such embodiments, when the user enables the session, the system may be prompted to propose actions based on the current state of the codebase. In some embodiments, the session may be paused or disabled in response to a user editing a file in the codebase. In such embodiments, proposed actions that have not yet been implemented may be discarded and the machine learning model is applied to updates to the state of the codebase to generate new proposed actions.

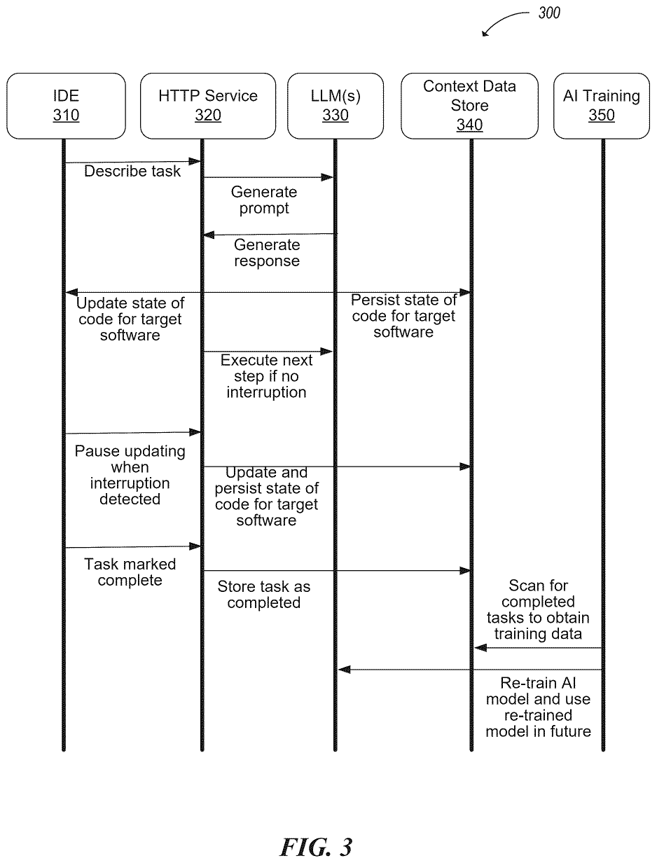

The session store 260 stores context data used by the system 230. The session store 260 may be similar to the context data store 340, described below in connection with FIG. 3. The oracle service 262 may provide the session service 246 with access to one or more machine learning models. In some embodiments, at least a portion of the one or more machine learning models are fine-tuned based on data associated with one or more users. The oracle LLM store 264 may store the fine-tuned machine learning models that are trained by the oracle training service 266. The oracle training service 266 may obtain context data from the session store 260 and use the context data to fine-tune, or further train, one or more machine learning models. In some embodiments, the context data obtained by the oracle training service 266 is context data associated with one or more users.

FIG. 3 is a data flow diagram of a data flow 300 between various components of the agentic code generation system, according to various embodiments described herein. The data flow 300 begins with an IDE 310 transmitting data indicating a task related to a target software to code generation service 320. The IDE 310 may be similar to the IDE 212, described above in connection with FIG. 2. In some embodiments, the data indicating a task includes an indication of one or more files associated with the target software to be edited, one or more other files relevant to the task, an indication of context data relevant to the task, other data used to describe a task, or a combination thereof.

The HTTP service 320 generates a prompt based on the description of the task and transmits the prompt to one or more LLMs 330. In some embodiments, the prompt is generated based on the description of the task and an indication of a current state of code for the target software. In some embodiments, the prompt includes instructions for the LLMs 330 to select an action from a selected list of actions. In some embodiments, the set of actions include: listing all files in a directory for the current project; opening a file as the current file; moving a cursor in the current file; inserting text at the current cursor in the current file; deleting text at the current cursor in the current file; saving current contents of the current file; opening a file for context and not as the current file; opening a web page for context; transmitting a request via one or more protocols (e.g. HTTP, FTP, SMTP, etc.); asking a question and receiving an answer; executing a command on the user's device; adding a task to be actively completed; editing an active task; removing an active task; marking a task as completed; cumulatively editing multiple files, such as by editing string mutations made to a set of edited files; the current active file in the user's IDE; the current cursor position in the user's IDE; using a tool to make a read, write, or otherwise access a code file; other actions; or a combination thereof. In some embodiments, listing all files in a directory for the current project is performed by using recursion and a max depth parameter. In some embodiments, moving a cursor in the current file, inserting text at the current cursor in the current file, deleting text at the current cursor in the current file, or a combination thereof, are integrated in a single action that can specify one or more edits to a file. In some embodiments, at least a portion of the actions are able to be automatically performed by the system 230, require permission from a user to be performed by the system 230, or are forbidden to be performed by the system 230. In some embodiments, at least a portion of the actions include actions to change documentation, other files associated with the development of the target software, or a combination thereof, associated with the codebase.

In some embodiments, as part of generating the prompt, the system 230 generates a representation of a state of the codebase. In some embodiments, the representation of the state of the codebase includes tasks, contexts, current file, file listings, prior action results, questions/answers, shell outputs, other session states, or a combination thereof. The system 230 may generate a prompt based on the representation of the state of the codebase.

In some embodiments, actions generated by the system are represented as tool definitions grouped by namespace. In such embodiments, a tool definition may include a name, a type, a description, a parameter schema, one or more content type constraints for arguments, other tool definition data, or a combination thereof. In some embodiments, the tool definitions may be used to constrain or validate the model outputs as tool calls. In some embodiments, the tool definitions may be used to reproduce the same tooling contract for fine-tuning.

In some embodiments, an action is associated with one or more hashes to ensure that the action is correctly applied to the code. In such embodiments, the one or more hashes may include an expected hash which is derived from a prior read or cached file event, and which corresponds to the file that is to be changed. In some embodiments, before an edit is automatically made to a file, the expected hash is compared to a hash generated based on the contents of the file. In some such embodiments, if the comparison indicates that the files are the same file the edit may be automatically made to the file, and if the comparison indicates that the files are not the same file the edit is prevented from being made to the file. By using hashes to verify which files are to be edited, the system is able to prevent unexpected file contents, the wrong files, or a combination thereof, from being edited. The hashes are also able to be used to determine whether any changes were made to the file that the system has not yet detected. In some embodiments, once the edit has been made, a new hash is generated for the file and stored as the expected hash for the file.

The LLMs 330 generate a response to the prompt that takes at least one of the selected actions. The response is transmitted to the HTTP service 320. Following the generation of the response, the state of the code for the target software is updated in the IDE 310 and stored in a context data store 340 for access by an LLM 330 in the future. In some embodiments, the state of code is updated in a browser, one or more local files of the user device, the IDE 310, or a combination thereof. In some embodiments, the update to the state of code includes manipulating one or more user interface elements displayed via the user device to illustrate the actions included in the generated response. In some embodiments, the state of the code is also stored in the context data store with the one or more actions indicated by the response to the prompt.

In some embodiments, the system stores (or “persists”) data regarding the state of the codebase (“artifacts”) in a storage system based on one or more hashes of content. In some embodiments, the data regarding the state of the codebase includes data corresponding to one or more action payloads (such as declarative parameters), one or more results of requests for approval of an action (such as a policy decision, a user consent outcome, etc.), one or more executor results (such as success or failure of the executor to implement the action, new hashes, diagnostic data, results of action execution, results of executed commands, responses from tools calls, etc.), one or more action history graphs, one or more snapshots of the session or state of the codebase (such as tasks, contexts, current file pointers, caches, etc.), other data regarding the state of the codebase, or a combination thereof. In some embodiments, by persisting the artifacts, the system is able to prevent duplication of code, provide tamper-evident referencing of code, replay the generation of code from a last action pointer and parent links, extract one or more “net actions” for training or summarization, or a combination thereof. In some embodiments, the system identifies “net changes” used to complete a task based on artifact data. In some embodiments, the net changes are used to identify actions between task creation and task completion and identify “net actions” that transform the initial state of the code to the final state of the code. In some embodiments, the net actions are used to generate one or more training examples, such as by generating prompts from intermediate net-action states and paring each with the corresponding next net action and parameters.

The data flow 300 continues to execute the next step to modify the initial code of the target software toward the final code of the target software, which may include generating additional prompts and responses until the final code of the target software is achieved. If the IDE 310 detects that a user has interacted with the code while the state of code is being updated, a request to pause the updating is transmitted to the HTTP service 320. The request to pause may include a current version of the state of the code that includes the user's interactions. In some embodiments, the user requests to pause the modification of the code via the IDE 310 before manually making changes to the code. In such embodiments, the state of the code may be updated after the user has indicated that the modification of the code by the system 230 is to continue.

In response to the request to pause, the state of the code for the target software is caused to be updated and persisted in the context data store 340. In some embodiments, in response to the request to pause, any incomplete action is abandoned. In such embodiments, by abandoning the incomplete action, the context data store may already be up-to-date when the request to pause is received. In some embodiments, when the pause ends, any edits made by the user to the state of the code, documentation, other files associated with the development of the target software, or a combination thereof, are persisted before actions to modify the code are generated. The state of the code is then used to generate a new prompt and new response until the task is completed.

The data flow 300 continues to execute until the task is marked as completed in the IDE 310, until the task is detected to be completed by one or more aspects of the system 230 (such as when a proposed action indicates that the task is completed), or a combination thereof. The IDE 310 transmits data to the HTTP service 320 indicating that the task has been completed. The HTTP service 320 stores an indication that the task is complete with data corresponding to the actions, prompts, responses, other data generated to complete the task, or a combination thereof in the context data store 340.

The AI training module 350 identifies completed tasks stored in the context data store 340. The AI training module 350 may determine which actions were taken to complete the task and attribute the actions to the user, the LLMs 330, or a combination thereof. In some embodiments, the prompts, actions, action input, sequence of actions, state of the code throughout the sequence of actions, other data stored in the context data store 340, or a combination thereof, are used to generate training data for the LLMs 330.

The generated training data is used by the AI training module 350 as supplemental training for the LLMs 330. In some embodiments, when the supplemental training is complete, the system 230 is configured to use the latest version of the LLMs 330. In some embodiments, the supplemental training is reinforcement learning. In some embodiments, the training data is labeled for task-level objectives.

In an example embodiment, the training data includes training examples such as: one or more rendered prompts; one or more selected actions or tools; one or more action arguments formatted per schema and content-type constraints; an outcome or label (such as success, failure, reasons for success or failure, etc.); or a combination thereof. In some embodiments, a tool manifest is exported as a standalone artifact defining tool or action schemas. In such embodiments, the generation of training data is able to remain decoupled from runtime code and reduce distribution shift.

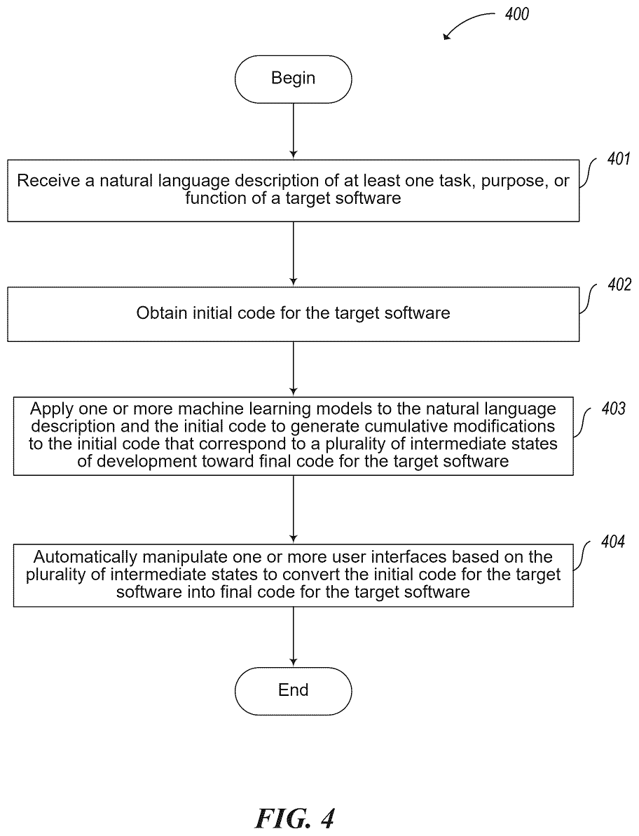

Those skilled in the art will appreciate that the acts shown in FIG. 4 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 4 is a flow diagram of a sample process 400 to convert initial code into final code for target software, according to various embodiments described herein.

The process 400 begins, after a start block, at act 401, where a natural language description of at least one task, purpose, or function of a target software is received. In some embodiments, the natural language description includes an indication of one or more files associated with the target software to be edited, one or more other files relevant to the task, an indication of context data relevant to the task, other data used to describe a task, or a combination thereof.

The process 400 proceeds to act 402, where initial code for the target software is obtained. In some embodiments, the initial code for the target software is obtained from a user device, such as the user device 210 described above in connection with FIG. 2. In some embodiments, the initial code for the target software is obtained from one or more data stores, version control systems, databases, other code storage systems, or a combination thereof.

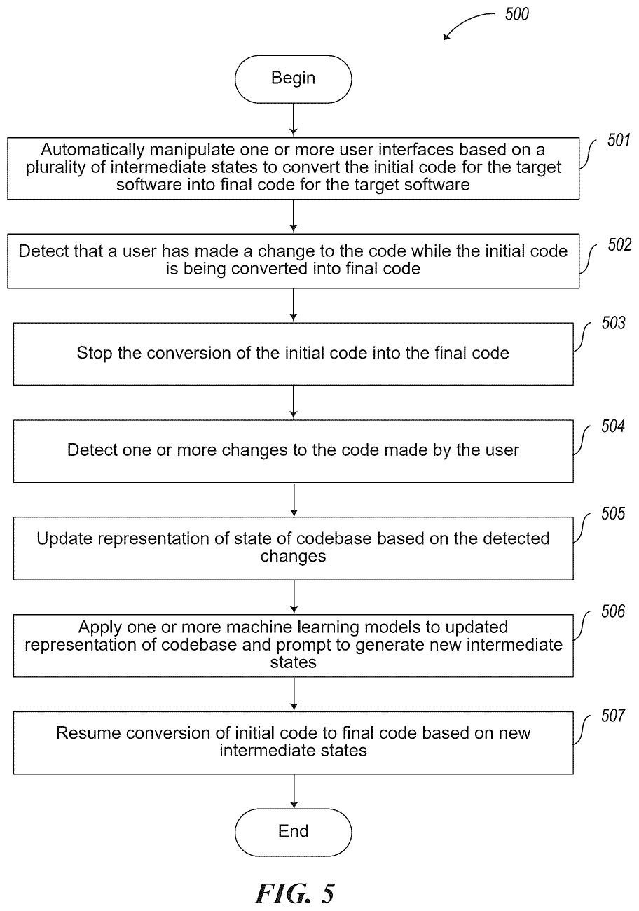

The process 400 proceeds to act 403, where one or more machine learning models are applied to the natural language description to generate cumulative modifications to the initial code that correspond to a plurality of intermediate states of development toward final code for the target software. In some embodiments, at least one machine learning model is applied to a first intermediate state of development to generate one or more actions to be performed to modify the code from a previous state of development to the first intermediate state of development. In some embodiments, at least a portion of the one or more actions may be actions to gather information that is used to modify development files, such as code files, documentation, other files associated with the development of the target software, or a combination thereof. In some embodiments one or more interactions with a cumulative modification corresponding to the intermediate state are obtained and a subsequent cumulative modification is generated based on a revised intermediate state in accordance with the interactions. In some such embodiments, the process 500 described below in connection with FIG. 5 is used to generate the subsequent cumulative modification.

The process 400 proceeds to act 404, where one or more user interfaces are automatically manipulated based on the plurality of intermediate states to convert the initial code for the target software into final code for the target software. In some embodiments, automatically manipulating a user interface includes automatically causing edits to be made to a code file and displaying the edits as they are made.

After act 404, the process 400 ends.

FIG. 5 is a flow diagram of a sample process 500 to respond to user interaction with a code document during the conversion of initial code into final code, according to various embodiments described herein.

The process 500 begins, after a start block, at act 501, where one or more user interfaces are automatically manipulated based on a plurality of intermediate states to convert initial code for a target software into final code for the target software. In some embodiments, act 501 is performed in a similar manner to act 404, described above in connection with FIG. 4.

The process 500 proceeds to act 502, where it is detected that a user has made a change to the code while the initial code is being converted into the final code. In some embodiments, the change may be a change to code displayed in one or more of the user interfaces that are manipulated based on the plurality of intermediate states. In some embodiments, the change may be a change to a file that stores at least a portion of the code.

The process 500 proceeds to act 503, where the conversion of the initial code into the final code is stopped.

The process 500 proceeds to act 504, where one or more changes made to the code by the user are detected.

The process 500 proceeds to act 505, where a representation of the state of the codebase is updated based on the detected changes.

The process 500 proceeds to act 506, where one or more machine learning models are applied to the updated representation of the codebase and a prompt to generate one or more new intermediate states. In some embodiments, act 506 is performed in a similar manner to act 403.

The process proceeds to act 507, where the conversion of initial code to final code is resumed based on the new intermediate states.

After act 507, the process 500 ends.

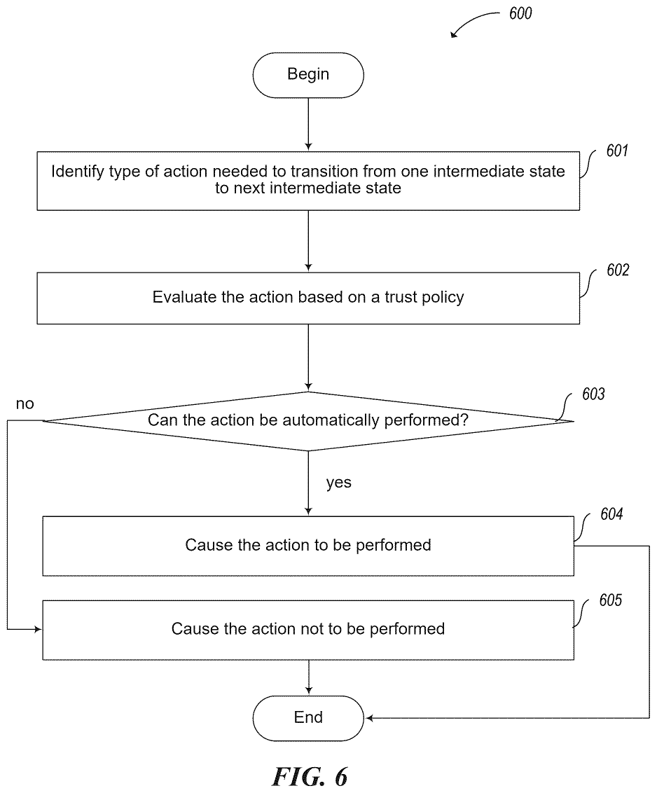

FIG. 6 is a flow diagram of a sample process 600 to determine whether an action associated with an intermediate state can be automatically performed, according to various embodiments described herein.

The process 600 begins, after a start block, at act 601, where a type of action needed to transition from one intermediate state to the next intermediate state is detected.

The process 600 proceeds to act 602, where the action is evaluated based on a trust policy.

The process 600 proceeds to act 603, where it is determined whether the action can be automatically performed based on the evaluation of the action. If the action can be automatically performed, the process proceeds to act 604, otherwise the process proceeds to act 605.

At act 604, the action is caused to be performed. After act 604, the process 600 ends.

At act 605, the action is caused not to be performed. In some embodiments, it is determined whether the trust policy indicates that user approval is required to perform the action. If the trust policy indicates that user approval is required to perform the action, a request for instructions is displayed to a user via one or more user interface elements. In such embodiments, the action may be caused to be performed based on the instructions received via the one or more user interface elements. After act 605, the process 600 ends.

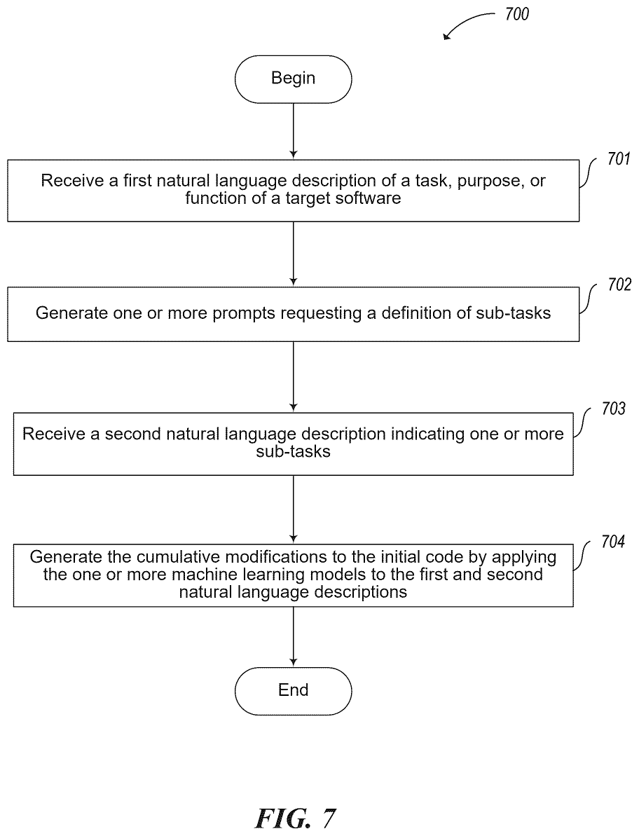

FIG. 7 is a flow diagram of a sample process 700 to identify one or more sub-tasks for the conversion of the initial code into final code for the target software, according to various embodiments described herein.

The process 700 begins, after a start block, at act 701, where a first natural language description of a task, purpose, or function of a target software is received. In some embodiments, act 701 is performed in a similar manner to act 401, described above in connection with FIG. 4.

The process 700 proceeds to act 702, where one or more prompts requesting a definition of one or more sub-tasks are generated. In some embodiments, the one or more prompts are generated by applying one or more machine learning models to the first natural language description.

The process 700 proceeds to act 703, where a second natural language description indicating one or more sub-tasks is received. In some embodiments, acts 702 and 703 are repeated until all subtasks are specified. In some such embodiments, acts 702 and 703 are repeated if the subtasks are not sufficiently specified or disambiguated. In such embodiments, the one or more machine learning models may generate a determination of whether the subtasks are sufficiently specified or disambiguated.

The process 700 proceeds to act 704, where the cumulative modifications to the initial code are generated by applying the one or more machine learning models to the first and second natural language descriptions.

After act 704, the process 700 ends.

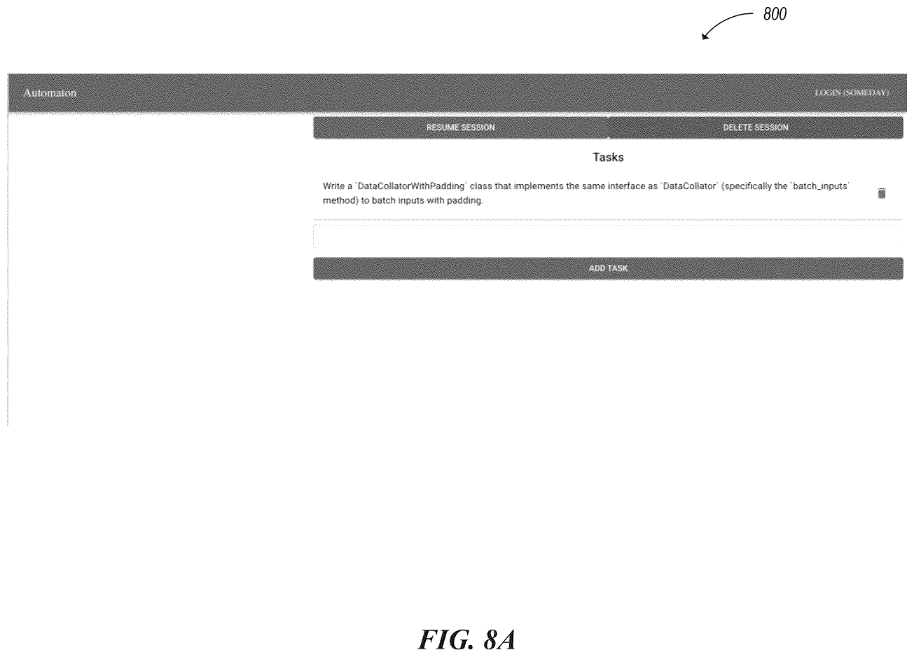

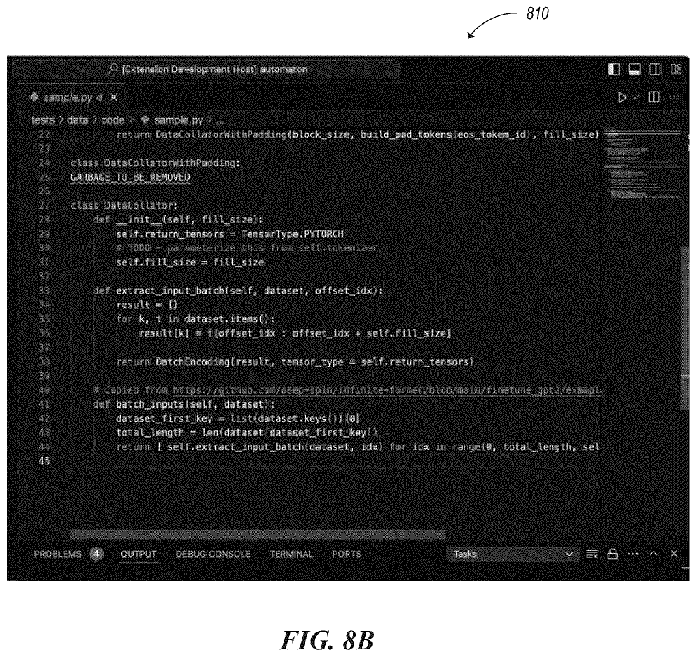

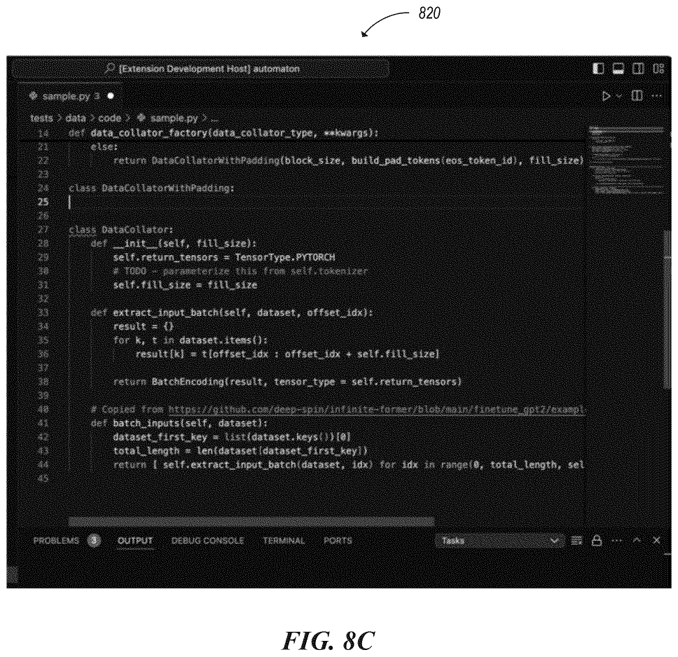

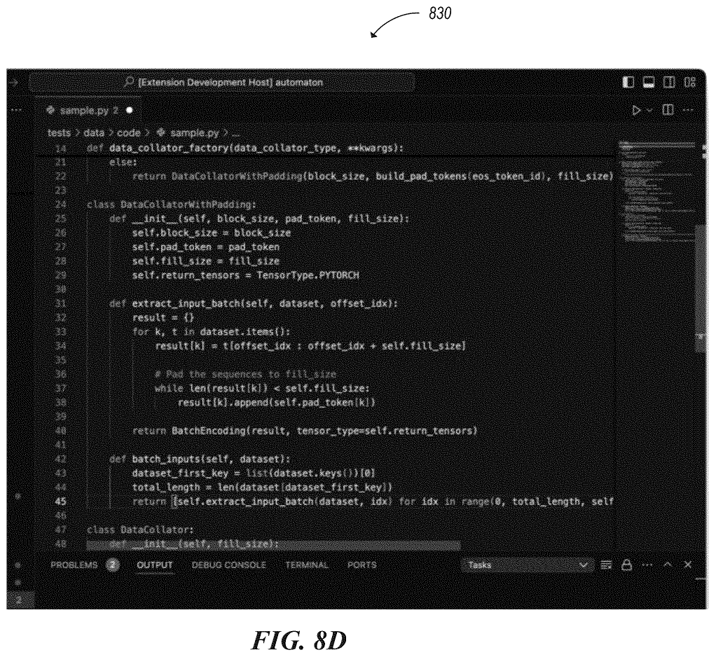

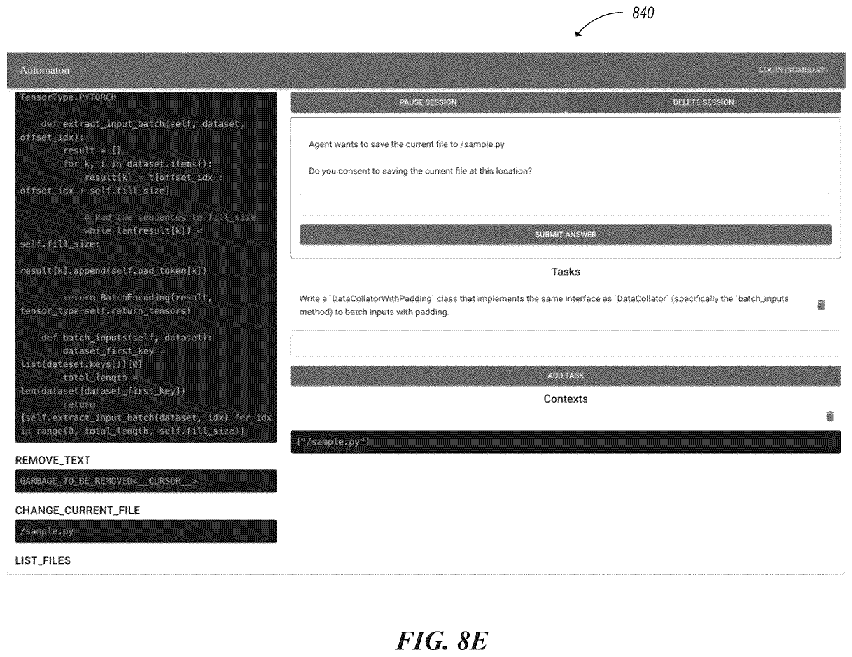

While FIG. 8A and each of the display diagrams discussed below show a display whose formatting, organization, informational density, etc., is best suited to certain types of display devices, those skilled in the art will appreciate that actual displays presented by the system may differ from those shown, in that they may be optimized for particular other display devices, or have shown visual elements omitted, visual elements not shown included, visual elements reorganized, reformatted, revisualized, or shown at different levels of magnification, etc.

FIG. 8A is a display diagram of a first user interface 800, according to various embodiments described herein. The user interface 800 is a sample user interface displayed in a browser or application for transmitting one or more natural language text descriptions to an agentic code generation system, such as the system 230. The user interface 800 may include one or more user interface elements for receiving a natural language text description of one or more tasks, purposes, or functions of a target software. The sample user interface 800 includes an example task, which is to “write a ‘DataCollatorWithPadding’ class that implements the same interface as ‘DataCollator’”.

FIG. 8B is a display diagram of a second user interface 810, according to various embodiments described herein. The second user interface 810 is a sample user interface displayed in an IDE, such as the IDE 214 described above in connection with FIG. 2, in which actions for transitioning from one intermediate state to a next intermediate state are displayed. As can be seen in the user interface 810, the ‘DataCollatorWithPadding’ class has been entered into the IDE interface, but still needs some processing. In the example of the user interface 810, the system 230 has automatically created the class and entered the text of the class into the IDE.

FIG. 8C is a display diagram of a third user interface 820, according to various embodiments described herein. The third user interface 820 is another sample user interface displayed in an IDE and continues the example above with regards to the creation of the ‘DataCollatorWithPadding’ class. The third user interface 820 shows that some extraneous non-code text was automatically removed from the code for the ‘DataCollatorWithPadding’ class by the system 230.

FIG. 8D is a display diagram of a fourth user interface 830, according to various embodiments described herein. The fourth user interface 830 is another sample user interface displayed in an IDE and continues the example above with regards to the creation of the ‘DataCollatorWithPadding’ class. The fourth user interface 830 shows that additional definitions for variables in the class were automatically added to the code representing the ‘DataCollatorWithPadding’ class by the system 230.

FIG. 8E is a display diagram of a fifth user interface 840, according to various embodiments described herein. The fifth user interface 840 is another sample user interface displayed in a browser or application for interacting with an agentic code generation system, and continues the example described above with respect to the ‘DataCollatorWithPadding’ class. The user interface 840 includes a change log user interface element on the left side of the user interface that indicates the changes made to the code as part of adding ‘DataCollatorWithPadding’ class to the code. The user interface 840 also includes user interface elements indicating a request to the user to approve the changes made to the code before they are saved and user interface elements indicating the original natural language description of the task performed by the agentic code generation system.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method, comprising:
receiving, from one or more users, a natural language description of at least one of a task, purpose, or function of a target software;
obtaining initial code for the target software;
outputting, using one or more trained machine learning models, cumulative modifications to the initial code that correspond to a plurality of intermediate states of development toward final code for the target software, wherein for each intermediate state of at least a subset of the plurality of intermediate states:
obtaining, from the one or more users, interactions with a cumulative modification corresponding to the intermediate state; and
generating subsequent cumulative modifications based, at least in part, on a revised intermediate state in accordance with the interactions;
outputting the final code for the target software; and
updating the one or more trained machine learning model based, at least in part, on the final code and the interactions obtained with the cumulative modifications.

2. The method of claim 1, comprising:
identifying one or more actions, including one or more user interface interactions, to arrive at a next intermediate state of the plurality of intermediate states from a previous intermediate state of the plurality of intermediate states; and
controlling a user interface based on the one or more user actions to modify the code for the target software.

3. The method of claim 1, comprising:
identifying one or more actions to arrive at a next intermediate state of the plurality of intermediate states from a previous intermediate state of the plurality of intermediate states;
determining whether at least one action of the one or more actions can be performed automatically based on a trust policy; and
based on a determination that at least one action cannot be performed automatically, receiving input regarding the performance of the at least one action.

4. The method of claim 1, comprising:
generating one or more natural language prompts requesting additional information regarding sub-tasks of the at least one of task, purpose, or function, of the target software;
receiving input identifying one or more sub-tasks in response to the one or more natural language prompts; and
outputting the cumulative modifications to the initial code that correspond to a plurality of intermediate states of development toward the final code for the target software based on the one or more sub-tasks.

5. The method of claim 1, comprising:
identifying, using the one or more trained machine learning models, whether one or more of the intermediate states progresses one or more tasks associated with the cumulative modifications towards completion;
attributing completion of the one or more tasks with the identified one or more intermediate states; and
designating the attribution of the completion of the one or more tasks with the identified one or more intermediate states as training data for further training the one or more trained machine learning models.

6. The method of claim 1, wherein obtaining interactions with a cumulative modification corresponding to the intermediate state comprises:
detecting that a modification has been made to a document associated with code for the target software.

7. The method of claim 6, comprising:
in response to detecting the modification to the document:
revising a current intermediate state to include the modification to the document; and
causing the one or more trained machine learning models to generate subsequent cumulative modifications based on the revised current intermediate state.

8. One or more instances of non-transitory computer-readable media collectively having contents configured to cause a computing system to perform a method comprising:
receiving, from one or more users, a natural language description of at least one of task, purpose, or function of a target software;
obtaining initial code for the target software;
outputting, using one or more trained machine learning models, cumulative modifications to the initial code that correspond to a plurality of intermediate states of development toward final code for the target software, wherein for each intermediate state of at least a subset of the plurality of intermediate states:
obtaining, from the one or more users, interactions with a cumulative modification corresponding to the intermediate state; and
generating subsequent cumulative modifications based, at least in part, on a revised intermediate state in accordance with the interactions;
outputting the final code for the target software; and
updating the one or more trained machine learning model based, at least in part, on the final code and the interactions obtained with the cumulative modifications.

9. The one or more instances of non-transitory computer-readable media of claim 8, wherein the method further comprises:
identifying one or more actions, including one or more user interface interactions, to arrive at a next intermediate state of the plurality of intermediate states from a previous intermediate state of the plurality of intermediate states; and
controlling a user interface based on the one or more user actions to modify the code.

10. The one or more instances of non-transitory computer-readable media of claim 8, wherein the method further comprises:
identifying one or more actions to arrive at a next intermediate state of the plurality of intermediate states from a previous intermediate state of the plurality of intermediate states;
determining whether at least one action of the one or more actions can be performed automatically based on a trust policy; and
based on a determination that at least one action cannot be performed automatically, receiving input regarding the performance of the at least one action.

11. The one or more instances of non-transitory computer-readable media of claim 8, wherein the method further comprises:
generating one or more natural language prompts requesting additional information regarding sub-tasks of the task, purpose, or function, of the target software based on the task, purpose, or function, of the target software;
receiving input identifying one or more sub-tasks in response to the one or more natural language prompts; and
outputting the cumulative modifications to the initial code that correspond to a plurality of intermediate states of development toward final code for the target software based on the one or more sub-tasks.

12. The one or more instances of non-transitory computer-readable media of claim 8, wherein the method further comprises:
identifying, using the one or more trained machine learning models, whether one or more of the intermediate states progresses one or more tasks associated with the cumulative modifications towards completion;
attributing the completion of the one or more tasks with the identified one or more intermediate states; and
designating the attribution of the completion of the one or more tasks with the identified one or more intermediate states as training data for the one or more trained machine learning models.

13. The one or more instances of non-transitory computer-readable media of claim 8, wherein obtaining interactions with a cumulative modification corresponding to the intermediate state comprises:
detecting that a modification has been made to a document associated with code for the target software.

14. A system comprising:
a computing device configured to:
receive, from one or more users, a natural language description of at least one of task, purpose, or function of a target software;
obtain initial development files for the target software;
output, using one or more trained machine learning models, cumulative modifications to the initial development files that correspond to a plurality of intermediate states of development toward final development files for the target software, wherein for each intermediate state of at least a subset of the plurality of intermediate states:
obtain, from the one or more users, interactions with a cumulative modification corresponding to the intermediate state; and
generate subsequent cumulative modifications based, at least in part, on a revised intermediate state in accordance with the interactions;
output the final development files for the target software; and
update the one or more trained machine learning model based, at least in part, on the final development files and the interactions obtained with the cumulative modifications.

15. The system of claim 14, wherein the computing device is further configured to:
identify one or more actions, including one or more user interface interactions, to arrive at a next intermediate state of the plurality of intermediate states from a previous intermediate state of the plurality of intermediate states; and
control a user interface based on the one or more user actions to modify the development files.

16. The system of claim 14, wherein the computing device is further configured to:
identify one or more actions to arrive at a next intermediate state of the plurality of intermediate states from a previous intermediate state of the plurality of intermediate states;
determine whether at least one action of the one or more actions can be performed automatically based on a trust policy; and
based on a determination that at least one action cannot be performed automatically, receive input regarding the performance of the at least one action.

17. The system of claim 14, wherein the computing device is further configured to:
generate one or more natural language prompts requesting additional information regarding sub-tasks of the task, purpose, or function, of the target software based on the task, purpose, or function, of the target software;
receive input identifying one or more sub-tasks in response to the one or more natural language prompts; and
output the cumulative modifications to the initial development files that correspond to a plurality of intermediate states of development toward final development files for the target software based on the one or more sub-tasks.

18. The system of claim 14, wherein the computing device is further configured to:
identify, using the one or more trained machine learning models, whether one or more of the intermediate states progresses one or more tasks associated with the cumulative modifications towards completion;
attribute the completion of the one or more tasks with the identified one or more intermediate states; and
designate the attribution of the completion of the one or more tasks with the identified one or more intermediate states as training data for the one or more trained machine learning models.

19. The system of claim 14, wherein to obtain interactions with a cumulative modification corresponding to the intermediate state, the computing device is further configured to:
detect that a modification has been made to a document associated with development files for the target software.
